(19) United States
(12) Patent Application Publication
(10) Pub. No.: US 2025/0001736 A1
(43) Pub. Date: Jan. 2, 2025

(54) Glazing for Electric Heating, Method of Manufacturing the Same and Use of the Same

(71) Applicant: Pilkington Group Limited, Nr. Ormskirk, Lancashire (GB)

(72) Inventors: Alastair FRENCH, Merseyside (GB); Mark Andrew CHAMBERLAIN, Ormskirk Lancashire (GB); Jonathan Peter VOSS, Croston Lancashire (GB)

(73) Assignee: Pilkington Group Limited, Nr. Ormskirk, Lancashire (GB)

(21) Appl. No.: 18/708,908

(22) PCT Filed: Nov. 4, 2022
(86) PCT No.: PCT/GB2022/052799

§ 371 Date: May 9, 2024

(30) Foreign Application Priority Data
Nov. 10, 2021 (GB) 2116143.5

(51) Int. Cl. B32B 17/10; B32B 3/26; B32B 38/00

(52) U.S. Cl. CPC B32B 17/10036; B32B 3/266; B32B 17/10385; B32B 17/10935; B32B 17/10981; B32B 38/145; B32B 2250/04; B32B 2307/302; B32B 2307/7376; B32B 2329/06

(57) ABSTRACT

The present invention concerns a glazing for electric heating, comprising a first glass sheet, a first masking layer around the periphery of the first glass sheet, an aperture in the first masking layer for a sensor, a second glass sheet bonded to the first glass sheet by a ply of interlayer material, a carrier film positioned between the ply of interlayer material and the first glass sheet, an electric heating element on the carrier film, and a second masking layer on the carrier film. The second masking layer positioned on a carrier film causes less stress in the glass sheets during moulding and thus less optical distortion. The invention also concerns a method of manufacturing the glazing and use of the glazing for example as a window for a vehicle.

### FIELD OF THE INVENTION

The invention is a glazing for electric heating, a method of manufacturing the same and use of the same, for example, as a window for a vehicle.

### BACKGROUND OF THE INVENTION

Glazings for electric heating comprising a glass sheet, a masking layer on the glass sheet and an aperture in the masking layer for a sensor are well known. Typically, an electric heating element is provided for defogging or defrosting the aperture, so that the sensor can transmit and receive data through the aperture.

EP3118036A1 (Sakamoto) discloses a windshield comprising a glass sheet to which a mask layer has been applied. An amount of expansion caused by heat during a moulding process for the mask layer is different from that for the glass sheet. As a result, distortion of an image seen through the glass sheet occurs near a boundary between the mask layer and an opening. An information acquisition device is configured in the opening such that the influence of distortion occurring in a range from the edge of the opening is reduced, or a passage range of light to be emitted or received by the information acquisition device passes through a range near a centre of the opening.

US2017297310A1 (Mannheim Astete) describes a black band on glass to protect polyurethane adhesive by blocking ultraviolet light. During a bending process, the black band absorbs more radiant heat than glass. Temperature gradients of tens of degrees centigrade arise over a short distance, resulting in optical distortion known as a “burn” line along an inner edge of the black band. Solution to a burn line distortion problem is to print an obscuration directly on a surface of a plastic film laminated between at least two sheets of thermoplastic interlayer. Plastic film made of polyethylene terephthalate (PET) and printed obscuration has lower distortion measured in dioptres and has improved Modulation Transfer Function (MTF). No heating element is disclosed.

There remains a need for an alternative glazing for electric heating.

### Objectives of the Invention

An objective of the invention is to provide a glazing for electric heating having a predetermined amount of distortion. Another objective is to provide a simple method of manufacturing a glazing for electric heating having a predetermined amount of distortion.

### SUMMARY OF THE INVENTION

In a first aspect, the present invention provides a glazing for electric heating comprising the features set out in claim 1.

The invention provides a glazing for electric heating, comprising a first glass sheet; a first masking layer around the periphery of the first glass sheet; an aperture in the first masking layer for a sensor; a second glass sheet bonded to the first glass sheet by a ply of interlayer material; a carrier film positioned between the ply of interlayer material and the first glass sheet; an electric heating element positioned on the carrier film; and a second masking layer positioned on the carrier film.

The invention is greatly advantageous because a glazing having a second masking layer positioned on a carrier film causes less stress in the glass sheets during moulding and thus less distortion.

Surprisingly, the inventors have found that a second masking layer positioned on a carrier film defining an edge of an aperture for a sensor allows an aperture in the first masking layer to be larger. As a result, distortion due to the first masking layer is not in a field of view of the sensor.

Furthermore, a second masking layer positioned on a carrier film allows the second masking layer to move relative to the first glass sheet during a method of manufacturing the glazing. As a result, different thermal expansion coefficients of the second masking layer and the first glass sheet do not lead to distortion.

A result of the invention is that the glazing meets industrial test requirements for distortion, defogging and defrosting, for example of a vehicle window.

Preferably, the second masking layer is on an opposite surface of the carrier film than the electric heating element.

Preferably, the electric heating element is in contact with the first glass sheet.

Preferably, the second masking layer has an internal edge, wherein the shape of the internal edge is selected from straight, arcuate, oval, circle, triangle, square, rectangle, parallelogram or trapezoid. Each shape may be open or closed.

Preferably, the second masking layer has an external edge and has a width between the external edge and the internal edge, wherein the width is in a range from 1 to 100 mm, more preferably from 3 to 30 mm, most preferably from 5 to 25 mm.

Preferably, the internal edge of the second masking layer is spaced from an edge of the first masking layer by a distance, wherein the distance is in a range from 1 to 50 mm, more preferably from 2 to 20 mm, most preferably from 3 to 10 mm.

Preferably, the carrier film is polyvinyl butyral (PVB). PVB is advantageous because it also serves as an adhesive and flows during a step of permanent bonding using an autoclave in a method of manufacturing the glazing.

Preferably, a thickness of the carrier film is 1 mm or less, more preferably 100 μm or less, most preferably 50 μm or less.

Preferably, a ratio of a total area of the carrier film to a total surface area of the glazing is not more than 15%, more preferably not more than 5%, most preferably not more than 3%.

Preferably, the electric heating element is selected from a conductive coating, conductive tracks, conductive wires, or a combination thereof.

Preferably, the electric heating element is a conductive coating comprising a layer selected from silver, transparent conductive oxide, tin oxide, or fluorine doped tin oxide.

Preferably, the electric heating element is conductive tracks comprising silver print, silver nanowires, carbon nanotubes, or graphene or etched copper.

Preferably, the electric heating element is conductive wires comprising copper, tungsten, or silver.

Preferably, the electric heating element is a conductive coating having sheet resistance less than 325 ohms/square, more preferably less than 20 ohms/square, most preferably less than 7 ohms/square.

Preferably, a power density in the electric heating element is in a range from 100 to 3,000 W/m², more preferably from 200 to 2,000 W/m², most preferably from 300 to 1,000 W/m².

Preferably, first and second busbars are arranged on the carrier film along opposite edges of the electric heating element.

Preferably, first and second busbars are obscured by the second masking layer.

Preferably, first and second busbars comprise silver. First and second busbars may be printed using a conductive ink comprising silver powder, silver spheres, graphite powder, graphite rods, carbon nanotubes or glass flakes having a conductive coating. First and second busbars may be copper strip. First and second busbars may be etched copper, preferably the same material as etched copper conductive tracks of the electric heating element.

Preferably, conductive tracks have width in a range from 1 μm to 5 mm, more preferably from 5 μm to 4 mm, most preferably from 10 μm to 1 mm.

In a second aspect, the present invention provides a method of manufacturing a glazing comprising the steps set out in claim 12.

The invention provides a method of manufacturing a glazing according to the invention, comprising steps: providing a first glass sheet, depositing a first masking layer around the periphery of the first glass sheet, arranging an aperture in the first masking layer for a sensor, bonding a second glass sheet to the first glass sheet by a ply of interlayer material, and comprising steps before bonding of positioning a carrier film between the ply of interlayer material and the first glass sheet or the second glass sheet, providing an electric heating element on the carrier film, and depositing a second masking layer on the carrier film.

Preferably, the second masking layer is deposited by digital printing.

Preferably, the first masking layer is deposited by screen printing.

Preferably, the conductive coating is deposited by sputtering, more preferably by Chemical Vapour Deposition (CVD). Preferably, the conductive track is provided by etching a layer of conductive material, more preferably a layer of copper. Preferably, the conductive wires are embedded in the carrier film by a wire-laying device.

Preferably, the step of providing an electric heating element on the carrier film is before the step of depositing a second masking layer on the carrier film.

Preferably the step of bonding a second glass sheet to the first glass sheet by a ply of interlayer material is after the step of positioning a carrier film between the ply of interlayer material and the first glass sheet.

In a third aspect, the present invention provides use of a glazing according to the invention as a heated window of a vehicle for land, sea, and air, for example as a windshield, a rear window, a side window or a roof window of a motor vehicle. The invention may also be used as a window in a building, or a window in a refrigerator door, or in street furniture.

The invention will now be further disclosed by non-limiting drawings, non-limiting examples, and a comparative example.

### BRIEF DESCRIPTION OF THE DRAWINGS

FIG. 1 is an embodiment of the invention having a straight internal edge.

FIG. 2 is a cross-section on a line A-A of FIG. 1.

FIG. 3 is an embodiment of the invention having a rectangular internal edge.

FIG. 4 is a cross-section on a line A-A of FIG. 3, heating element on inner sheet.

FIG. 5 is as FIG. 4, but the second masking layer is on the inner sheet.

FIG. 6 is as FIG. 4, but the heating element is on the outer sheet.

FIG. 7 is as FIG. 4, but the second masking layer is on the outer sheet.

### DETAILED DESCRIPTION OF THE INVENTION

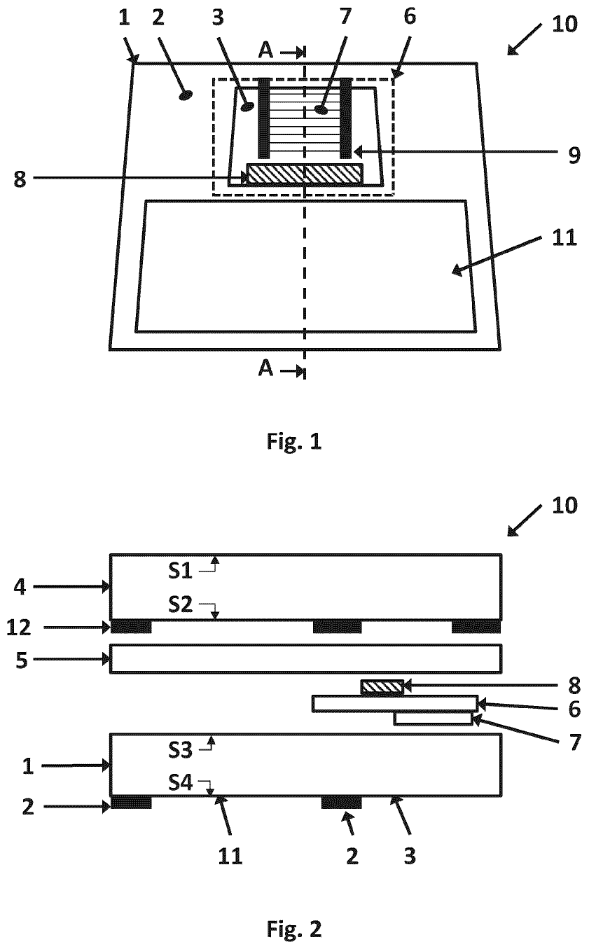

FIG. 1 discloses a glazing (10) for electric heating according to the invention comprising a first glass sheet (1) and a first masking layer (2) deposited on a surface of the first glass sheet (1).

The first glass sheet (1) is preferably soda lime silica glass, manufactured using the float process. Glass thickness is preferably in a range from 2 to 12 mm. The first glass sheet (1) may be toughened glass with surface stress greater than 65 MPa, or heat strengthened glass with surface stress in a range from 40 to 55 MPa, or semi-toughened with surface stress in a range from 20 to 25 MPa, or annealed glass.

The first glass sheet (1) may be an inner sheet of a pane of laminated glass (10). The pane of laminated glass (10) is for fitting to a body, such as a vehicle, so that the first glass sheet (1) faces inside the body. The first masking layer (2) is deposited on surface 4 (S4) of the pane of laminated glass (10), numbered from surface 1 (S1) facing outside.

The first masking layer (2) may comprise a black enamel deposited by screen printing black ink in a selected region on the first glass sheet (1). The first glass sheet (1) is then baked at a predetermined temperature and for a predetermined time so that the printed ink becomes a hard enamel. Advantageously, the first masking layer (2) extends around a periphery of the glazing (10) to mask an adhesive material, such as polyurethane, used to bond the glazing (10) to a vehicle body (not shown).

An aperture (3) is arranged in the first masking layer (2) for a sensor (not shown). The sensor may be a camera, an RFID tag, or any electronic device to transmit and receive electromagnetic radiation. For example, vehicle windows allow data acquisition for toll collection, or for Advanced Driver Assistance Systems (ADAS) to assist drivers in driving and parking functions. The sensor may be on a bracket on a surface of the first glass sheet (1). The sensor may be in a housing (not shown).

A carrier film (6) is provided in the glazing (10). A total area of the carrier film (6) is typically larger than a total area of the aperture (3).

The carrier film (6) is typically made of polyvinyl butyral (PVB). An electric heating element (7) is provided on a first surface of the carrier film (6). The electric heating element (7) is typically conductive lines comprising silver print or etched copper or conductive wires.

A second masking layer (8) is provided on a second surface of the carrier film (6). The second masking layer may be any shape. For example, the second masking layer (8) may be a band in the shape of a closed rectangle. The second masking layer (8) may extend between an internal edge of the first masking layer (2) and the electric heating element (7).

FIG. 2 discloses a cross-section on the line A-A of FIG. 1 of the glazing (10) according to the invention.

First glass sheet (1) and second glass sheet (4) and bonded together by a ply of interlayer material (5).

First masking layer (2) is on a surface of the first glass sheet (1) facing away from the ply of interlayer material (5). Typically, a first part of the first masking layer (2) forms an obscuration band along a top edge of the first glass sheet (1). The aperture (3) for a sensor is between the first part of the first masking layer (2) and a second part of the first masking layer (2). An unmasked region (11) is between the second part of the first masking layer (2) and a third part of the first masking layer (2) along a bottom edge of the first glass sheet (1).

The carrier film (6) is positioned between the first glass sheet (1) and the ply of interlayer material (5). The heating element (7) is between the carrier film (6) and the first glass sheet (1). The second masking layer (8) is on an opposite surface of the carrier film (6) than the heating element (7) facing the ply of interlayer material (5).

A third masking layer (12) is deposited on a surface of the second glass sheet (4) facing the ply of interlayer material (5). Third masking layer (12) obscures at least part of the second masking layer (8).

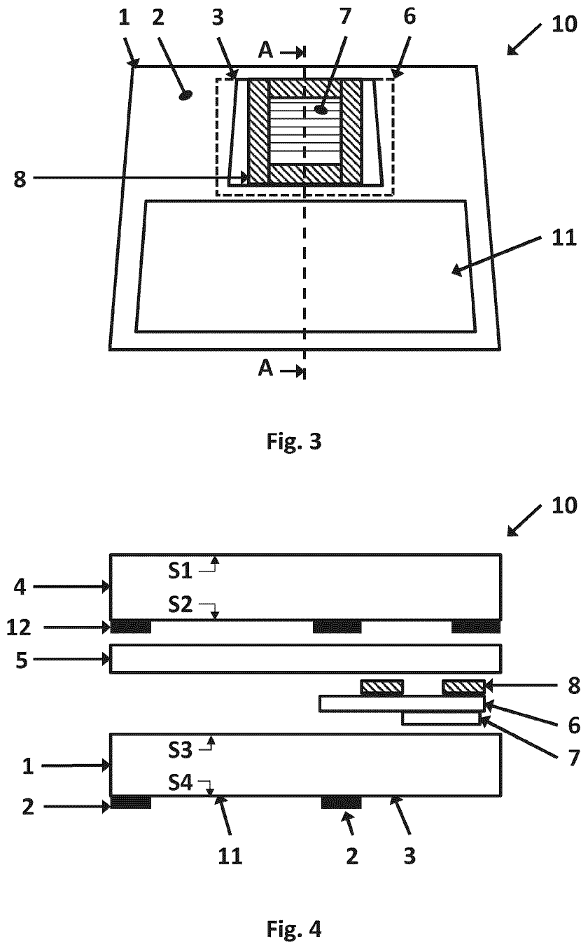

FIG. 3 discloses a glazing (10) according to the invention like FIG. 1 but further comprising a second masking layer (8) in the shape of an open rectangle. Open means having an inner edge, enclosed by an outer edge, where either or both edges is in the shape of a rectangle.

FIG. 4 discloses a cross-section on the line A-A of FIG. 3 of the glazing (10) according to the invention. The heating element (7) contacts the first glass sheet (1). This is advantageous for fast heating of surface 4 (S4), resulting in faster defogging.

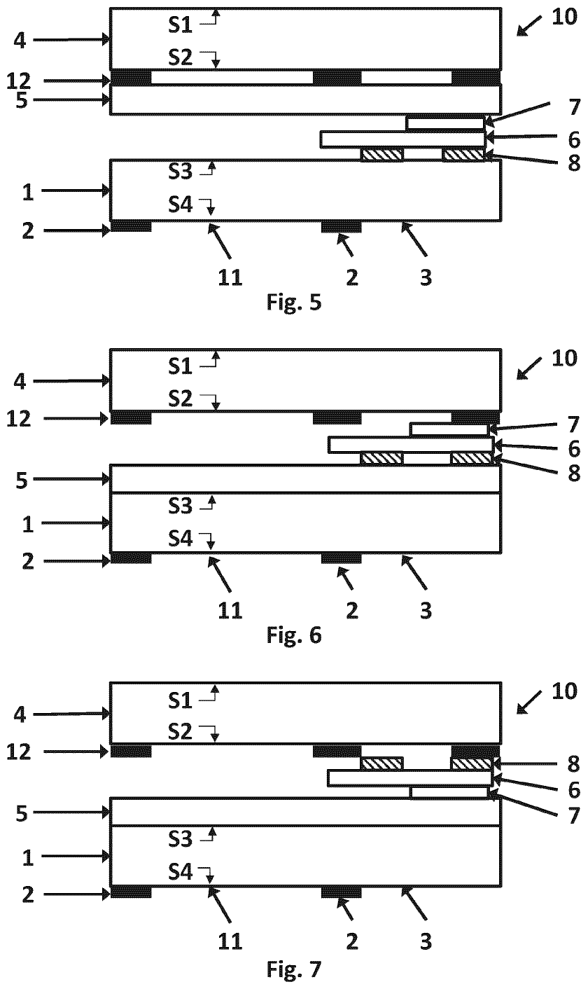

FIG. 5 is as FIG. 4 but the second masking layer (8) contacts the first glass sheet (1) and the heating element (7) contacts the ply of interlayer material (5). This is advantageous for fast heating of the ply of interlayer material, resulting in an optimal balance of firstly defogging surface 4 (S4) and secondly defrosting surface 1 (S1).

FIG. 6 is as FIG. 4 but the heating element (7) contacts the second glass sheet (4) and the second masking layer contacts the ply of interlayer material (5). This is advantageous for fast heating of surface 1 (S1), resulting in faster defrosting.

FIG. 7 is as FIG. 4 but the second masking layer (8) contacts the second glass sheet (4) and the heating element (7) contacts the ply of interlayer material (5). This is advantageous for fast heating of the ply of interlayer material, resulting in an optimal balance of firstly defrosting surface 1 (S1) and secondly defogging surface 4 (S4).

The heating element (7) may comprise printed conductive tracks having width in a range from 400 μm to 700 μm, preferably comprising silver particles. The heating element (7) may comprise copper wires having diameter in a range from 70 μm to 300 μm. The heating element (7) may comprise tungsten wires having diameter in a range from 10 μm to 50 μm. The heating element (7) may be formed by etching a layer of copper on the carrier film (6) to provide conductive tracks having width in a range from 1 μm to 50 μm.

### KEY TO THE DRAWINGS

References in the drawings are as follows:
1—First glass sheet (inner sheet)
2—First masking layer
3—Aperture
4—Second glass sheet (outer sheet)
5—Ply of interlayer material
6—Carrier film
7—Electric heating element
8—Second masking layer
9—Busbar
10—Glazing
11—Unmasked region
12—Third masking layer
S1—First surface
S2—Second surface
S3—Third surface
S4—Fourth surface

1. A glazing for electric heating, comprising:
a first glass sheet,
a first masking layer around the periphery of the first glass sheet,
an aperture in the first masking layer for a sensor,
a second glass sheet bonded to the first glass sheet by a ply of interlayer material,
a carrier film positioned between the ply of interlayer material and the first glass sheet,
an electric heating element on the carrier film,
and a second masking layer on the carrier film.

2. A glazing according to claim 1, wherein the second masking layer is on an opposite surface of the carrier film than the electric heating element.

3. A glazing according to claim 1, wherein the electric heating element is in contact with the first glass sheet.

4. A glazing according to claim 1, wherein the second masking layer has an internal edge, wherein the shape of the internal edge is selected from straight, arcuate, oval, circle, triangle, square, rectangle, parallelogram or trapezoid.

5. A glazing according to claim 1, wherein the second masking layer has an external edge and a width between the internal edge and the external edge is in a range from 1 to 100 mm.

6. A glazing according to claim 1, wherein the internal edge of the second masking layer is spaced from an edge of the first masking layer by a distance, wherein the distance is in a range from 1 to 50 mm.

7. A glazing according to claim 1, wherein the carrier film consists of polyvinyl butyral.

8. A glazing according to claim 1, wherein a thickness of the carrier film is 1 mm or less.

9. A glazing according to claim 1, wherein the electric heating element is selected from a conductive coating, conductive tracks, conductive wires, or a combination thereof.

10. A glazing according to claim 1, wherein the electric heating element is conductive tracks comprising silver print, silver nanowires, carbon nanotubes, or graphene or etched copper.

11. A glazing according to claim 1, wherein power density in the heated coating is in a range from 100 to 3,000 W/m².

12. A method of manufacturing a glazing for electric heating, comprising steps:
providing a first glass sheet,
depositing a first masking layer around the periphery of the first glass sheet,
arranging an aperture in the first masking layer for a sensor,
bonding a second glass sheet to the first glass sheet by a ply of interlayer material,
and comprising steps before bonding of
positioning a carrier film between the ply of interlayer material and the first glass sheet or the second glass sheet,
providing an electric heating element on the carrier film,
depositing a second masking layer on the carrier film.

13. A method of manufacturing a glazing according to claim 12, wherein the second masking layer is deposited by digital printing.

14. A method of manufacturing a glazing according to claim 12, wherein the first masking layer is deposited by screen printing.

15. Use of the glazing according to claim 1 as a windshield, a rear window, a side window, or a roof window of a motor vehicle, or as a window in a building, or a window in a refrigerator door, or in street furniture.
